(19) United States
(12) Patent Application Publication
(10) Pub. No.: US 2011/0288888 A1
(43) Pub. Date: Nov. 24, 2011

(54) SYSTEM FOR CAPTURING, STORING, AND RETRIEVING REAL-TIME AUDIO-VIDEO MULTI-WAY FACE-TO-FACE INTERACTIONS

(75) Inventor: Krishna GAZULA, Lexington, MA (US)

(73) Assignee: IHAS INC, Lexington, MA (US)

(21) Appl. No.: 13/195,613

(22) Filed: Aug. 1, 2011

Related U.S. Application Data
(63) Continuation of application No. 12/609,409, filed on Oct. 30, 2009.

(51) Int. Cl. G06Q 50/00

(52) U.S. Cl. 705/3

(57) ABSTRACT

System associated with two or more remote users including but not limited to, patients, caregivers and medical professionals to interact face-to-face in real-time using audio and video streams, wherein each user is connected to the server system through a computer network, the system comprises a remote user interface connected with a centralized one-integrated system comprises hardware and software framework combination of central server and web browser, which allows to capture standardized data, records, content of the patient entered information and transactional activity relating this patient; stores the information captured into an integrated (EMR) module, and allows the extraction of stored information as desired and appropriate for the seeker of the information in order to be compliant with regulations, the authorized users may choose to capture video stream and record audio during the real-time interactions. The captured audio-video streams may be stored after indexing for intelligent search and retrieval.

### RELATED APPLICATION

This application is a continuation of and claims priority to U.S. patent application Ser. No. 12/609,409 entitled “Novel One Integrated System for Real-Time Virtual Face-to-Face Encounters” filed Oct. 30, 2009, incorporated by reference herein in its entirety.

### FIELD OF THE INVENTION

The invention relates to systems and methods of capture and storage of audio-video files in an integrated application which enables two or more remote users to interact face-to-face in real-time streaming system. The novel platform provides integrated application where in the capture and archiving is provided without having interference with real-time interactions and adhering to the defined medical compliance.

### BACKGROUND AND DESCRIPTION OF PRIOR ART

It is known in the prior art that healthcare environments, such as hospitals or clinics, include clinical information systems, such as hospital information systems (HIS), radiology information systems (RIS), clinical information systems (CIS), and cardiovascular information systems (CVIS), and storage systems, such as picture archiving and communication systems (PACS), library information systems (LIS), and Electronic Medical Records (EMR) or Electronic Health Records (EHR). Information stored may include patient medical histories, imaging data, test results, diagnosis information, management information, and/or scheduling information, for example. The information may be centrally stored or divided among a plurality of locations. Healthcare practitioners may desire to access patient information or other information at various points in a healthcare workflow. For example, during surgery, medical personnel may access patient information, such as images of a patient's anatomy, which are stored in a medical information system. Alternatively, medical personnel may enter new information, such as history, diagnostics, or treatment information, into a medical information system during an ongoing medical procedure.

RealNetworks, Inc. of Seattle, Wash., provides a system for transmitting streaming audio and video signals to users over the Internet. RealNetworks supplies a server that allows multiple users to simultaneously receive streaming audio and video. The real audio system requires that not only the client have additional software, but that the content provider have a separate server from their normal web server. For a client to receive a real audio broadcast, the client typically connects through their browser to a Web page with a reference to a real audio server. The client then accesses its separate real audio player program. The real audio player program then connects to the referenced real audio server. A significant drawback to such an arrangement is that the user must download the real audio player program. This program must then be installed on the user's computer. This may cause a number of problems for the user. For example, if the user is behind a firewall, or some security program, the client may not be able to receive the broadcast from the server. Additionally, the installation of any program may have conflicts with other programs. The program has the disadvantage of being platform specific. This means that a different program must be developed and downloaded for each type of computer that is to be used to access RealNetworks broadcasts. Additionally, the broadcasters of the streaming audio and video need to use the RealNetworks server, which is separate from the broadcasters' World Wide Web server (also referred to as the web server). This increases the broadcasters' security problems because now the broadcasters must be concerned with two separate servers. More importantly, this approach may open significant security holes and pose serious threat to the patient information. Hence it may be a non-starter for providing health care services.

Another example of a video and audio system that uses Internet like communications is the MBone. The MBone is a specialized communication network that allows for the distribution of streaming video and audio signals to multiple users. A specialized network is set up specifically to transmit MBone communications. A significant drawback of this system is that users must be connected to the specialized network. Additionally, users will be required to have specialized software on their computers to listen to and watch MBone transmissions. Again, this approach may offer security threats and hence may not be suitable for providing health care services.

Current advances in technologies related to Medical/healthcare delivery services use one or more applications to review a patient history, medical information and record information during interactions. The state of the applications today is disparate and requires un-friendly actions by the users to obtain information. For example, in order to review images within a imaging system (e.g. PACS—Picture Archiving and Communication System) while reviewing/updating medical records in an electronic medical records (EMR), the medical user will have to close EMR, login into PACS, review images, print/hand write information, close PACS, re-login into EMR and enter the collected information.

Current healthcare information technology software applications do not afford to annotate, comment or collaborate on specific patient information. Current systems allow for communication via email, whereby screen captures with annotations are attached to the email. Unfortunately, email systems are not integrated with EMR applications so that the comment threads can be stored for historical reference. Thus, systems and methods for improved annotation, comment and collaboration would be highly desirable. Systems and methods allowing discussion threads and annotations to be stored with an EMR would also be highly desirable.

The process is time consuming, inefficient and impairs productivity of the medical professionals. In results, healthcare delivery if costly and valuable time is lost in order to provide medical services to a needy patient.

### SUMMARY OF THE INVENTION

In view of the foregoing, embodiments of the present invention advantageously provide capture and storage of audio-video files in the iHAS application which enables two or more remote users to interact face-to-face in real-time using audio and video interactions. The video-audio stream capture and archiving to be provided without having to interfere with the real-time interactions while following regulatory compliance. The interactions may involve evaluating a patient's condition (e.g. wound, rash) during a real-time virtual encounter (or visit) by a medical professional. Further, the stored files can also help to record longitudinal information of a patient condition using audio-video stream.

The capture and storage of audio-video files to enhance quick search capabilities using iHAS algorithm to enhance productivity of healthcare professionals.

Yet another aspect of the invention relates to automatically archiving and storing each patient data file for long-term storage and retrieval from a central database server.

In order to overcome the noted deficiencies in the prior art, aspects of the system described herein capture patient's image data and combine it with patient demographic information into a single patient data file that is archived within a searchable database.

Still another aspect of the invention allows remote access to any patient data file from any device running web-browser software.

In addition to the foregoing attributes, the framework, in combination with the iHAS Screen, possess numerous other process advantages and benefits over known systems. The framework improves quality of care, enhances safety of patients, and increases satisfaction of all involved. The framework improves the efficiency of the medical professional and reduces the need for use of the healthcare facilities to treat the patient or the medical professional visiting the patient placed in an off-site (homecare, nursing home or assisted living). Hence the improved efficiency allows the medical professionals to gain additional abilities to treat new additional patients without having to increase both physical and human resources. Moreover, it brings benefits to the patient by eliminating the need for traveling to clinic/hospital/care-giver to get consultation which can be accomplished using the iHAS Single Computer Screen for the routine issues and to seek medical advice.

Further more, the framework, ihasClinic, in combination with the iHAS Single Computer Screen, ihasRemote, allows capturing the patient's physiological and vital data in real-time and store. The framework features allow semi- or full automation of the data capture, eliminating all the costs, delays and errors associated with manual operations of data capture and attaching to the patient's records.

The framework also allows the user (patient/medical professional) to retrieve and generate the desired reports to gain knowledge/understanding of the patient's health-status.

In view of the above, it is an object of the present invention to provide a novel healthcare access system which successfully brings all involved, any patient, medical professionals, care-givers and/or administrators, leading to increased efficiency while driving the healthcare costs down significantly.

The present invention is directed to the field of providing information related to medicine, engineering, education and training, law or any other area of interest via computer network.

### OBJECTS AND ADVANTAGES OF THE INVENTION

In view of the problems discussed above in prior art section, it is an object of the present invention to provide a system to capture and storage of audio-video files in the iHAS application which enables two or more remote users to interact face-to-face in real-time using audio and video. The capture and archiving to be provided without having to interfere with interactions while following regulatory compliance. The interactions may involve evaluate a patient's condition (e.g. wound, rash) during a real-time virtual encounter (or visit) by a medical professional. Further, the stored files can also help to record longitudinal information of a patient condition in audio-video.

The capture and storage of audio-video files to enhance quick search capabilities using iHAS algorithm to enhance productivity of healthcare professionals.

The iHAS approach is a mechanism for providing real-time virtual face-to-face encounters from a variety of remote locations, including the patient's home, rural healthcare centers, community healthcare centers, multi-specialty group practice centers and hospitals. This approach is designed to reduce healthcare disparities while improving a provider's productivity and efficiency, using our unique, secure and HIPAA compliant web-based system. The iHAS system is easy to use and allows physicians/nurses/other-healthcare-professionals to interact with patients/family-members/specialists from their normal office setting using a computer and webcam. Because of the unique ability of the iHAS system to present the medical record on the same screen used for the audio-video encounter, there is the potential for marked improvement in provider productivity and satisfaction. In addition, the system allows two or more participants to interact simultaneous, dramatically improving effectiveness and efficiency of the communication (as shown in FIG. 1). In summary, the iHAS approach provides two unique features:
(1) Virtual face-to-face visits between patients at home, family, nurses, advanced practice nurses, physicians, caregivers, health workers using real-time audio and video simultaneous interactions; and
(2) A Single Computer Screen solution achieved using our innovative and proprietary techniques, to bring together and display in real-time all essential components for the medical encounter. “Multi-centric system” that mimics in-office face-to-face visits, pulling all essential components of the medical encounter (audio-video, medical records, other information and patient specific intelligence, etc.) into a Single Computer Screen to optimize physician productivity and efficiency. The components simultaneously available on the screen include audio-video, electronic medical records (EMR)/application database, laboratory data, patient-entered vital signs data, home telehealth data from monitors, instructions, education/training information/documents, etc.). This unique technology allows providers to complete medical record documentation/progress-notes during a real-time virtual face-to-face encounter, thus markedly improving productivity of healthcare providers.

The iHAS system assists healthcare workers in collaborating with a patient and family to schedule appointments; maintenance and monitoring of health; review of clinical tests and follow up; access to specialists; medication reconciliation; education and training; dietary and social work consultations; counseling and advice on anxiety control in mental health issues, etc. The real-time virtual visits between patients and providers using the iHAS advanced and state-of-the-art system occur using personal computers (laptop/desktop/tablet PC, Playbook, and handhelds enabled with a browser) installed with a commonly available web browser (such as Microsoft Internet Explorer, Mozilla Firefox, etc.) and simple commercially available webcams, built-in webcams, or other such devices capable of video streaming. Patients and providers will require no other hardware or software components. The capabilities of the iHAS system include security standards (e.g. HIPAA compliance, data encryption, etc.) required for secure virtual face-to-face encounters. All functionality is provided and controlled from a centrally managed server, eliminating any complicated user setup or maintenance.

The iHAS approach is the first aggregator of all essential components of healthcare participant interactions (advanced use of real-time audio and video, with electronic medical records, lab systems, images, and other information) into a secure single computer screen.

The iHAS solution is an advanced “multi-centric system” that mimics in-office face-to-face visits and real-world scenarios involving patients, family/caregivers, providers, homecare agencies, community agencies, multi-specialty group practice centers and clinical support systems (EMR, lab system, PACS, etc.). This approach will enhance access and satisfaction of both the patient and providers, and is designed to eliminate/reduce unnecessary hospitalizations/readmissions/ER visits. Since patients with chronic illnesses often fail at home, the iHAS system provides vitally needed enhanced access to assess, intervene, and prevent deterioration requiring hospitalization or emergency services. This can lead to not only to marked improvement in quality of care and patient/provider satisfaction, but a reduction in healthcare costs as well.

The capabilities of the iHAS system adhere to security standards (including HIPAA) required for real-time virtual face-to-face encounters. The approach would help improve a clinician's productivity and time by enabling (1) rapid and comprehensive self-documentation of encounters, and (2) automation of indexing for documentation of encounters and storage in the iHAS system in order to provide rapid search and retrieval capabilities. The rapid search and retrieval capabilities are achieved by utilizing the Active Intelligent Engine of the iHAS system.

The iHAS platform goal is to provide an easy to use system and eliminate any user specific setup with the use of commonly available computer components and simple access through a web browser. The users (patients and providers) would need only a computer (desktop/laptop) and an inexpensive webcam. The application is designed to provider a user with an interface to easily navigate the features of the iHAS system by clicking on icons provided on the user dashboard.

The iHAS system brings collaborations to the participants seamlessly. For example. medical professionals who provide services, patients who seek healthcare services from one or more medical professionals, care-givers, and/or administrators to login using proprietary programming scripts that connects user interface (iHAS Screen) with the centralized one-integrated system (ihasClinic—hardware and software framework) after verifying the authentication of the user who is trying to connect with the system, allows capturing standardized data, records and content of the patients, store the information captured into Electronic Medical Records (EMR) module, apply an application suite that offers an integrated EMR with capabilities to collect and present standardized data from patients and medical professionals on the health status-changes, diagnosis and treatments bring efficiency and improved compliance, review mechanism and decision process to treat a patient.

The captured data is used for perpetuating a self-learning system, ihasAnalyst, that allows improved knowledge/understanding of patient health status. Both patients and medical professionals can learn on the patient health-status changes for improved preventive care and health management using iHAS Single Computer Screen. The client is available through a variety of interface devices such as desktop, laptop, PDA and cell phone. The client provides videoconferencing capabilities with a click of a button to have improved access and consultations with the medical professionals by the patients and the care-givers/family members.

A further object of the invention is to provide one integrated system that helps users—for example patients, healthcare services providers (medical professionals and administrators) and other professionals to login using remote user interface/client (ihasRemote) connected with a centralized one-integrated system (ihasClinic—hardware and software framework). The ihasClinic framework allows capturing standardized data, records, content of the patient entered information and transactional activity relating this patient. The framework further stores the information captured into integrated Electronic Medical Records (EMR) module, and allows the extraction of stored information as desired and appropriate for the seeker (patient, medical professionals, care-givers, and/or administrators) of the information. The programming scripts collect and store all the user activities, including that on accessed information from the system in order to be compliant with regulations (e.g. HIPAA). Data/records/content (“Information”) captured include input from the users through ihasRemote and a programming script that sends the information to ihasClinic and vise-a-versa. The information is generated one or more of the following methods (1) information input through programming script that is entered by the user using user input devices, including a computer key-board; (2) a digital picture or a video stream, including generated by a video camera; and (3) information generated by an audio device, including from a telephone, audio generating devices and from activated voice recording systems.

Yet further object of the invention is to provide an application suite that offers an integrated EMR with capabilities to collect and present standardized data from patients and medical professionals on the health status-changes, diagnosis and treatments bring efficiency and improved compliance, review mechanism and decision process to treat a patient. The captured data is used for perpetuating a self-learning system, ihasAnalyst, that allows improved knowledge/understanding of patient health status and providing decision support to treat the patient. Using iHAS Screen, both a patient and his/her medical professionals can learn on the patient health-status changes in order to make decisions on treatment plans for improved preventive care and health management. The client is available through a variety of interface devices such as desktop, laptop, PDA and cell phone. The client provides video and audio conferencing capabilities with a click of a button to have improved access and consultations with the medical professionals by the patient and care-givers.

A further object of the invention is to provide a system that is designed to adapt standards as they evolve. ihasAnalyst is designed and setup to use Clinical Practice Guidelines (CPG) issued by AHRQ to provide the analysis and treatment recommendations for the medical professionals and guidance to the patients to seeks answers from the medical professionals. The benefits of ihasClinic are that it can be configured to provide approved standard guidelines and also to standardized decision support across medical professionals irrespective of medical professionals experience level as well as skill set. Moreover, the medical professionals are often several years behind updating their knowledge from the recent development in providing the treatment plans. Therefore, the framework is capable of integrating with systems providing evidence-based decision support for diagnosis and treatment based on the recorded responses from the patient through the decision support systems. The benefits from the system are many but not limited to the following: They offer a readily accessible reference, providing selective access to guideline knowledge.

The invention offers numerous benefits and advantages over known healthcare virtual/online systems. In particular, the invention utilizes network capabilities and programming scripts to facilitate remote communications (both audio and video streaming, capturing and storing high-resolution digital images, capturing health parameters monitoring and storing, and activated voice response system) between two or more participants to utilize the information stored as part of the patient medical/health records which allows saving time and resources for all the participants, thereby affording healthcare access improvement as well as user cost reductions. Moreover, the framework allows geographically located patients to get access to their medical professionals with a click of a button and reach their medical professionals anytime from anywhere in real-time and have virtual face-to-face encounter. It allows the medical professionals to reach their geographically located patients and check their health-status anytime from anywhere. Moreover, the framework makes it easy for the medical professionals to have consultations with the specialists on the patient's health-status and get disease management and treatment course without having to meet in person or moving the patient to the specialist offices or hospitals majority of the times, leading to reduction in health-care costs.

### BRIEF DESCRIPTION OF THE DRAWINGS

These and other objects and advantages will become more apparent after consideration of the ensuing description and the accompanying drawings, wherein:

FIG. 1 shows a schematic of the iHAS framework, representing components making real-time virtual collaboration sessions/visits/encounters possible using real-time audio-video and all the necessary information needed for making the virtual encounter productive and efficient.

FIG. 2 shows a schematic of iHAS framework describing 3-tier architecture to enable a real-time virtual face-to-face collaborative encounter.

FIG. 3 shows iHAS recommended physical architecture for deploying iHAS framework in an enterprise to meet all necessary security, regulatory and compliance requirements to maintain participant's privacy and data/information security.

FIG. 4: illustrates Single Computer Screen during a real-time interactions session between a patient (monitored for body weight at home), family member, a nurse and a physician, wherein the graph demonstrates healthcare team access to patient records during the interactions.

FIG. 5 is a snapshot showing body bruises of a patient, interacting with his healthcare team to describe newly developed body bruises, and the healthcare team referring to progress notes and a snapshot captured during the real-time session by the patient and stored in iHAS system.

FIG. 6 is a iHAS system sharing a snapshot of a wound along with progress notes during a real-time virtual session.

FIG. 7 shows a flow chart describing process performed by iHAS system, according to invention principles.

### DETAILED DESCRIPTION

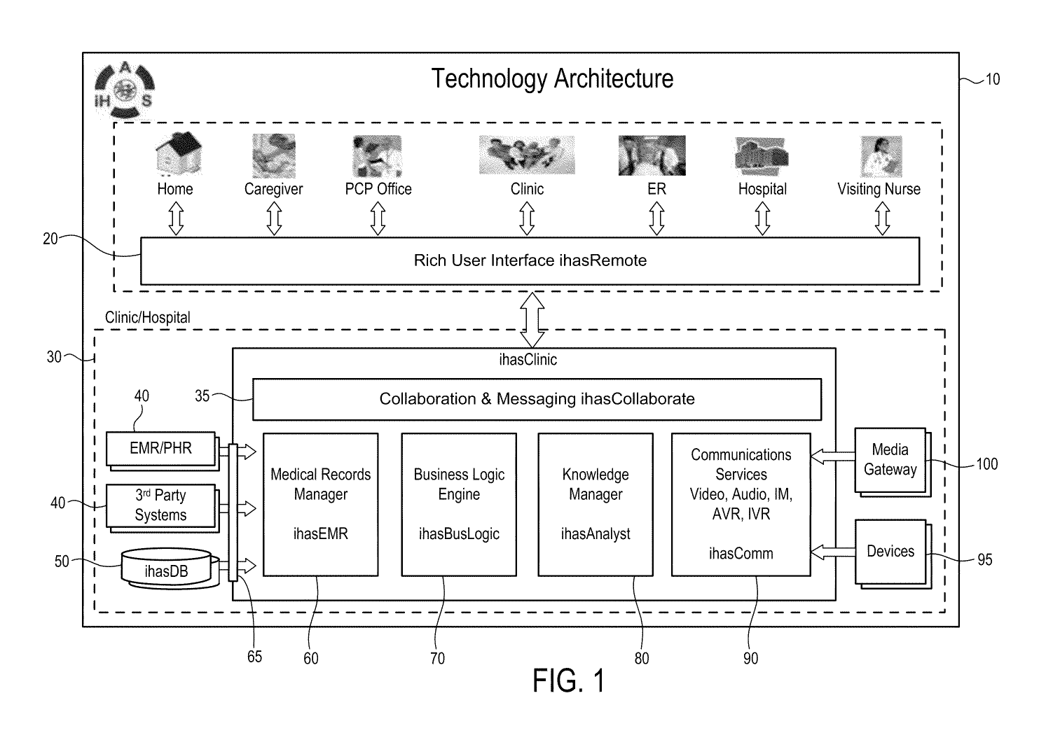

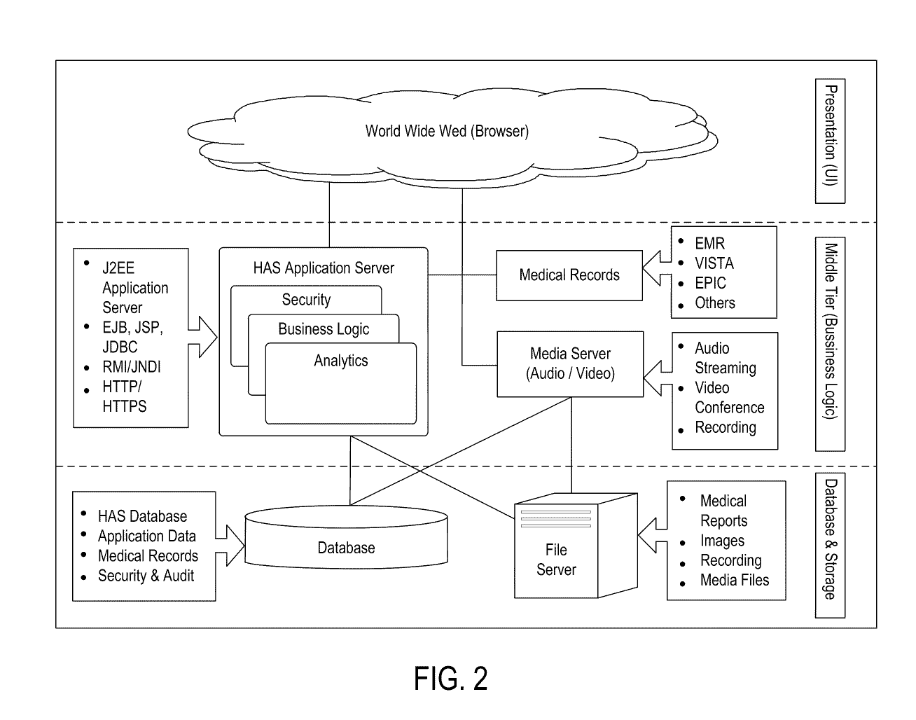

With reference to the drawings and, in particular, with reference to FIGS. 1-2, the invention comprises a technology framework, indicated generally at 10, assembly of several components to deliver an integrated solution that supports on the spot decision making for the players involved. In a healthcare setting, the players involved are the patient, his/her care-givers (including near and extended family members), medical professionals (both primary and specialists) and the administrators. The framework is defined by an integration framework, including J2EE engine, an enterprise service bus (ESB), application servers (including but not limited to JBoss, WebSphere, WebLogic, Apache, etc.), and other components as the technology evolves to meet the needs to the framework in order to deliver quick decision making and providing care advice.

The framework 30 provides capabilities with Applications/Systems Integrations Engine 40. The integrations include enterprise applications/systems, including Electronic Medical Records, EMR, (or Electronic Health Records, EHR, system), Medical Images systems (e.g. PACS), Lab systems, health monitoring devices/equipment/systems, etc. 40 and a related database 50 to capture, store and provide retrieval capabilities for all the data and records stored therein. These applications/systems are integrated into ihasClinic 30 ihasEMR module/application database 60 using our innovative interface, ihasBridge 65. The integration using the bridge 65 brings tight integration of enterprise application easy and fast as well as enables display of the data and/or records to the users during iHAS real-time collaborations based the role and authentication to access the system through iHAS Single Computer Screen, ihasRemote, 20. The programming engine, ihasBridge 65, to bridge the applications/systems and its database ihasDB 50 in order to provide access to these systems during a real-time collaboration session through the iHAS Single Computer Screen, ihasRemote 20. The data/records access requests and providing the access is provided based on the logic built in an engine, ihasBusLogic, 80. The ihasBusLogic 80 is a set of business rules and instructions, including those to check the user role, relationship tree, and their authentication to provide the right information that is desired by the user and what is allowed for the display.

The communication, including routing and delivery, between the iHAS Single Computer Screen(s) ihasRemote 20 and the framework ihasClinic 30 happens through the messaging engine ihasCollaborate 35. The messaging engine determines the components that it needs to activate based on the user preferred mode of communication and data/records the user is trying to access information, both read and/or write. The ihasCollaborate 35 allows the users (patient/family/physicians/nurse/healthcare workers/community workers/specialists) to join a real-time virtual face-to-face visit based a scheduled and confirmed visit by a patient or anyone related to patient (family/healthcare professionals). The visits are scheduled using ihasScheduler 36 in tight integration with ihasBusLogic 70 to allow authorized users to join a visit in order to be in compliance with regulations, including but not limited to HIPAA

Multiple communication channels are available to enable real-time audio-video collaborations/visits through Communications Services Engine 90. The Communications Services Engine 90 enables real-time audio-video collaborations using its Media Gateway 100. The Communication Services Engine 90 capabilities include, but not limited to, Real-Time Audio-Video Streaming and Recording 91, activated voice response (AVR) and/or interactive voice response (IVR) functionality through AVR/IVR Services API 92, and Instant Images API 93 (including high definition images if the plugged in devices 95 have the capabilities) capture and store using real-time video stream. In addition, Communications Services Engine 90 also allows the users to play/view stored videos 96, images 97 and medical image information 98 during a real-time collaboration session by the authorized users.

The iHAS framework architecture and high level components are shown in FIG. 2. The elements necessary to provide real-time virtual face-to-face visits using iHAS framework and represents outlines the various components of the framework 10. FIG. 2 represents how the components interact with each other as well as links to external resources/applications/systems/databases. The framework 10 logical view provides a breakdown of components and classes of the API. The iHAS framework is built on top of a 3-tier architecture—(1) Presentation, (2) Business Logic and (3) Database & Storage. The Presentation layer provides a Rich Internet Application (RIA) for the end-user (iHAS Single Computer Screen presentation, ihasRemote 20). The Business Logic layer implements the business logic of the iHAS framework 10, and built using J2EE standards and deployed on J2EE based application servers, including but not limited to JBoss, WebSphere, and WebLogic. The Database and File Server provides means of data and media storage that is managed by the iHAS framework.

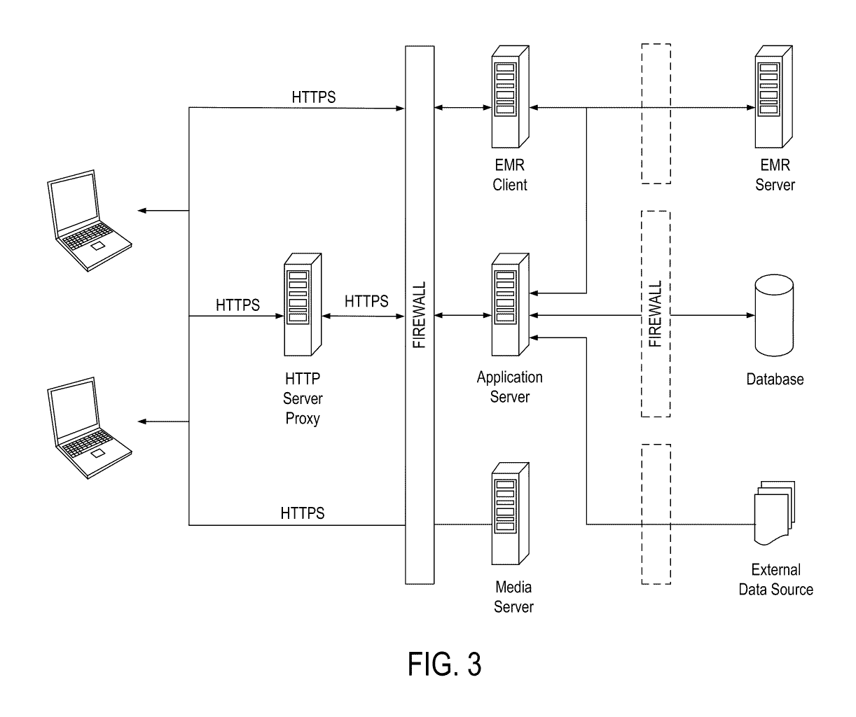

The logic and security layers are designed to operate behind firewall(s) in order to be compliant with regulations of real-time virtual face-to-face visits. The physical architecture of the iHAS framework with respect to enterprise applications/systems is described in FIG. 3. The iHAS framework 10 and it's two main components (ihasClinic 30 and ihasRemote 20) are designed to deliver a user friendly and easy to use system.

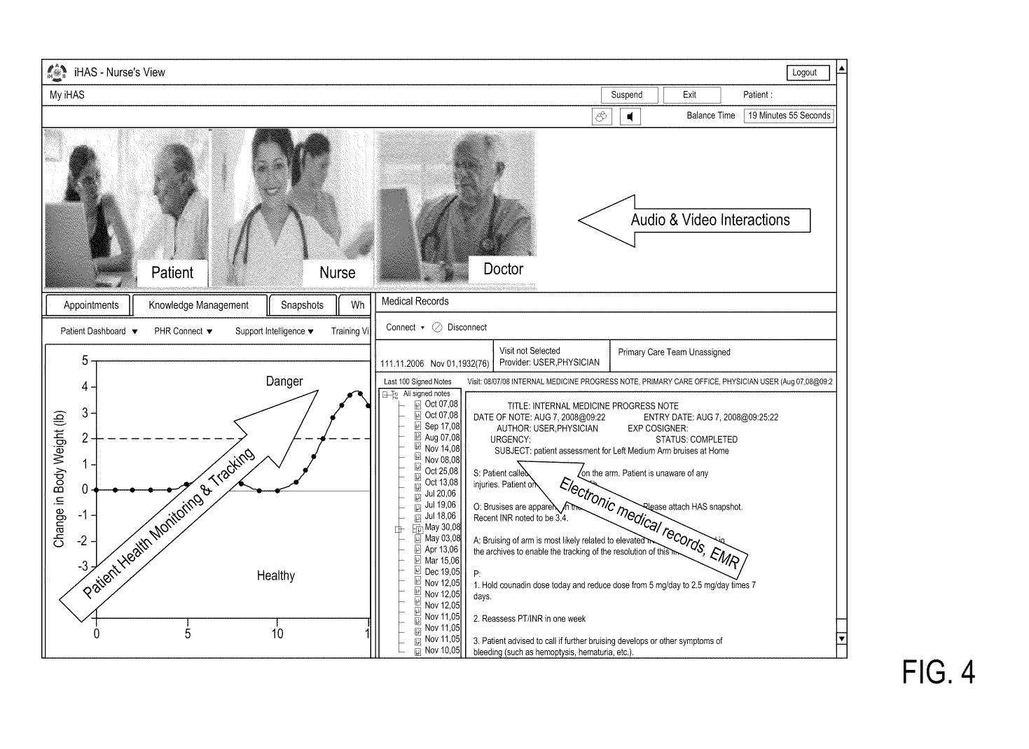

In the practice of the invention, FIGS. 4-7 show few detailed illustrations of real-time virtual face-to-face visits/encounters/collaborative-interactions using the iHAS framework. The framework enables the users to achieve a rapid and comprehensive electronic self-documentation of encounters. The framework allows two or more participants to interact in real-time and share data/information from external applications/systems during encounters/collaborative-sessions, leading to improved and efficient documentation during the encounters. This approach helps to achieve comprehensive documentation of encounters as well as rapid retrieval and inclusion of content from historic encounters through powerful search engine capabilities. The invention can be embodied in forms other than those described above.

As was previously mentioned, the capabilities of the iHAS system will adhere to security standards (including HIPAA) required for real-time virtual face-to-face encounters. This approach would help improve a clinician's productivity and time by enabling (1) rapid and comprehensive self-documentation of encounters, and (2) automation of indexing for documentation of encounters and storage in the iHAS system in order to provide rapid search and retrieval capabilities. The rapid search and retrieval capabilities are achieved by utilizing the Active Intelligent Engine within the iHAS framework.

Practicing the invention in an environment in which the healthcare professional uses a personal computer in some or all of the above-discussed ways can be advantageous, the iHAS system uses a web browser which allows participants to provide data/information (here after referred as “content”) related to the patient condition in multiple formats, including:
Patient Data (as schematically described in FIGS. 4-7): (1) typed text—reported by the patient before an encounter, edited/modified by during the encounter; (2) data on manually captured measurements, such as body weight, peak flows, etc.; (3) data from automated measurements such as from pulse oxymeter, digitized reading of lung and heart beat sounds, etc.; (4) snapshots, e.g. facial or wound condition, etc. and (5) audio and video recording of explanation of a condition or conversations
Progress Notes: Capture clinician notes into patient records during an encounter, (1) typed text, (2) snapshots, (3) audio and video recording of the conversations, (4) instant messages, IM, exchanges, and (5) details of whiteboard collaborations, including annotations, comments, drawings, etc.

As discussed above, the iHAS system employs a proprietary methodology which requires innovative integration of a new, dynamic approach for unifying information access provided by one of the next generation information search engines (such as Active Intelligent Engine (AIE) developed and marketed by Attivio). The system offers ease of use, secured information presentation, reliability, speed and efficiency of information search and presentation, and scalability. Hence, the capabilities of the iHAS framework are many but not limited to the following:
Provide capabilities to conduct virtual face-to-face real-time interactions involving two or more participants (a rural home patient, family, health workers, clinicians, specialists, dieticians, therapists, counselors and community workers).
One computer screen technology bringing a patient's medical information from different healthcare systems that are linked with the iHAS system.
Allow documentation during a real-time interaction session. The iHAS system provides a configurable template to enter progress notes by clinicians if they not already have a medical records system available to enter notes during a virtual session.
Enable advanced collaboration including real-time use of audio and video capabilities, Instant Messaging and Whiteboard during interactions with ability to record and store.
Ability to capture snapshots and attach them to reported symptoms or progress notes.
Unified Information Access: To ensure actions are based on all relevant information, the search engine will provide search for both structured data and unstructured content, consolidating results in one universal index.
Real-Time Fields for real-time updates, tagging, commenting and security changes. The search engine will handle document-level security changes in real time. The search engine real-time fields can be updated instantly without needing to retrieve and re-process the rest of the content.
Facilitate training and education during a virtual face-to-face visit by providing material, including videos that may have been recorded during a previous interaction session(s)
Provide capability to a patient/family/caregiver/health worker to schedule an appointment with clinician/specialist/therapist/counselor.
Enable a patient/family/caregiver to measure and enter vital signs measurements. Interface and capture data from tele health monitors that measure vital signs.
Present intelligent patient information to clinicians that is derived and retrieved from captured and stored data/information.

The iHAS system allows virtual consultations using real-time audio-video and provides transparent whiteboard capabilities for annotation and line markers to allow professionals to discuss stored images/snapshots during consultations. These annotated notes are captured and stored and attached to patient notes. Further, the system would allow audio-video recording of the consultations and archiving in the iHAS system. Hence the discussions would present powerful information when retrieved for future reference compared to simple text based clinical notes.

Another advantage of the system includes security, wherein it guards privacy and security of the users. As was previously mentioned, the system also incorporates authorization levels and roles to access information and to allow the interactions. In order to access and participate in the interactions, a user needs to have a created profile in the system with assigned roles and authorization to access the system using a graphical user interface (GUI).

Another advantage of the system may include intelligent search, extraction and presentation. As was previously mentioned, the iHAS system presents a clinician in its GUI a “Google” like search capability to intelligently look through patient's encounter data and information, and rapidly extract and present in the form user desires. The presentation format may include charts and graphs for clinicians (as shown in FIGS. 4-8).

The ihasRemote allows a user to login into the system to report a condition(s) of a patient by an authorized user and request an appointment with the medical team. A typical interactive screen allows the user to verify his/her demographic information, select pre-described symptoms or type-in condition descriptions. The reported symptoms/descriptions are stored and made available to medical professionals before/during/after a real-time face-to-face (both virtual and/or in-office) visits. This process brings improved productivity and efficiencies to providers of healthcare, enabling improved quality of care, enhanced patient safety, and increased satisfaction while reducing healthcare delivery costs.

FIG. 4 shows the real-time interaction between a patient (monitored for body weight at home), family member, a nurse and a physician. This view graph demonstrates healthcare team access to patient records during the interactions.

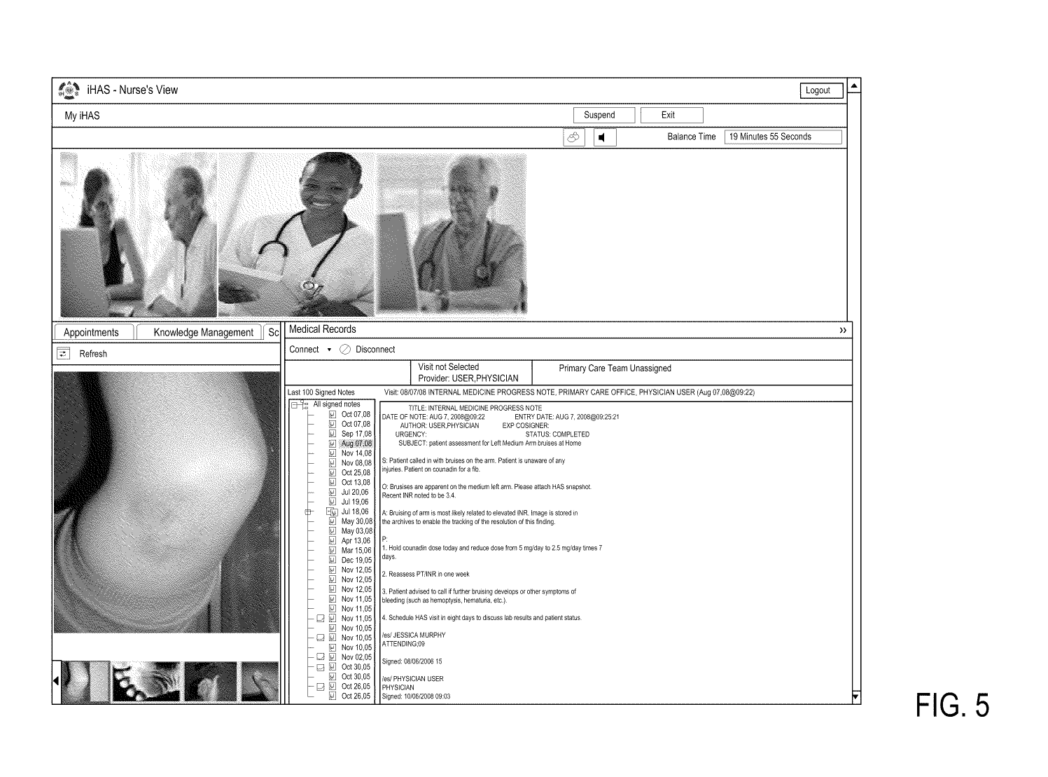

FIG. 5 is a snapshot showing body bruises, wherein patient is interacting with healthcare team to describe newly developed body bruises. The figure also clearly shows that the healthcare team referring to the progress notes of the patient which are stored in iHAS system during the real-time session.

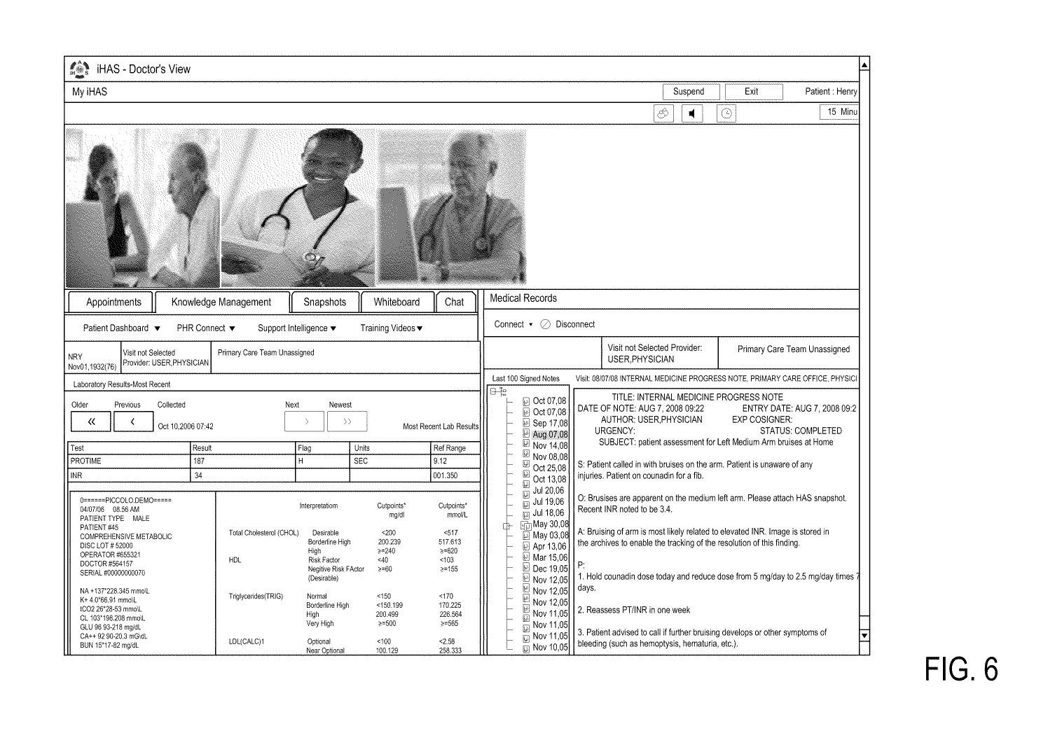

FIG. 6 illustrates a snapshot of iHAS system, where for example, the patient having a sutured wound along with progress notes during a real-time virtual session is disclosed.

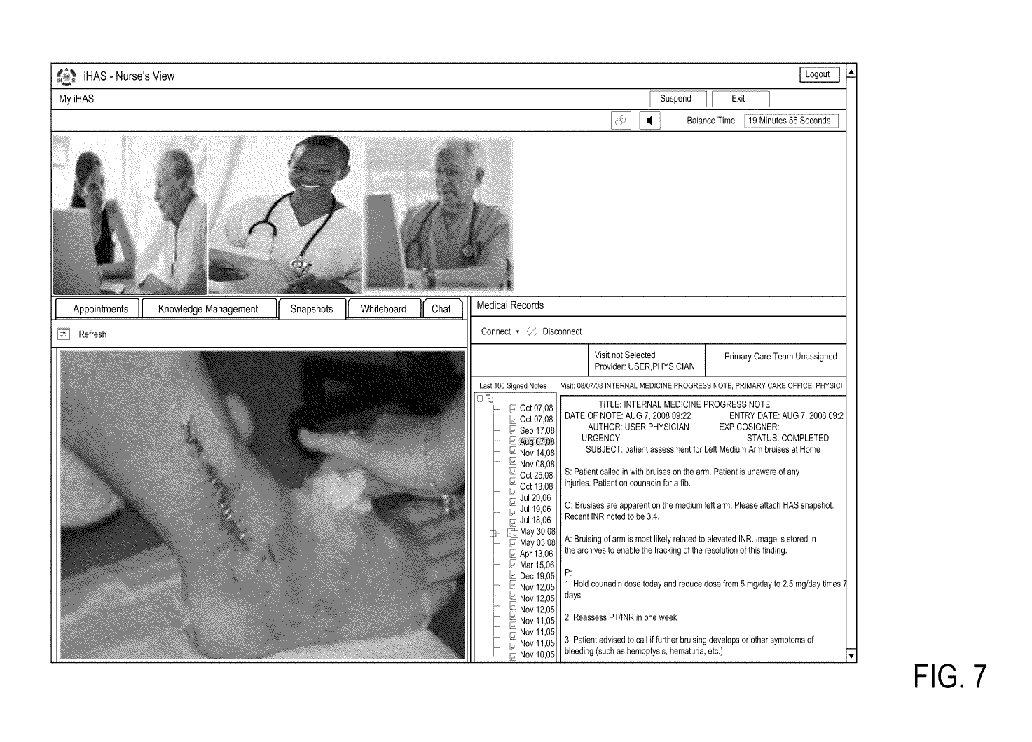

FIG. 7 shows a flow chart describing process performed by iHAS system, according to invention principles.

The present invention, therefore, provides an integrated framework in the form of a technology platform containing a plurality set of programming scripts, a database, an applications/systems (for example electronic medical records, EMR) integration engine, and a self-learning analytical engine that provide information for decision making by the patient, care-giver(s), medical professional(s) or by an administrator.

Although the above description contains many specificities, these should not be construed as limitations on the scope of the present invention but merely details illustrating the presently preferred embodiment. Many other embodiments of the present invention are possible, as this invention can be used in any field where it is desirable to remotely educate an individual. For example, teachers may utilize the present invention to assign lessons to their students, and employers may utilize the present invention to provide additional job training for their employees.

Although the invention has been described in connection with a preferred embodiment, it should be understood that various modifications, additions and alterations may be made to the invention by one skilled in the art without departing from the spirit and scope of the invention as defined in the appended claims.

What is claimed:

1. A system associated with two or more remote users including but not limited to, patients, caregivers and medical professionals (such as social workers, physiologists, mental health professionals, dieticians, physical therapists, etc.) to interact face-to-face in real-time using audio and video, wherein each user is connected to the server system through a computer network, the system comprises a remote user interface connected with a centralized one-integrated system, which allows to capture standardized data, records, content of the patient entered information and transactional activity relating this patient; stores the information captured into an integrated Electronic Medical Records (EMR) module or other clinical information systems, and allows the extraction of stored information as desired and appropriate for the seeker of the information and further the programming scripts collect and store all the user activities, including that on accessed information from the system in order to be compliant with regulations.

2. The system of claim 1, wherein the seeker of information may include patient, medical professionals, care-givers, and/or administrators.

3. The system of claim 1, wherein the centralized one-integrated system further comprises hardware and software framework combination of central server and web browser capable of capturing, storing and provide retrieval capabilities for all the data and records stored therein.

4. The system of claim 1, wherein said web browser being programmed to display a first interactive web page comprising display of audio video interactions, application data of the patient and plurality of operational mode graphical buttons; a communication service engine which enables real time audio-video collaborations through the single web browser.

5. The system of claim 1, further comprising multiple communication channels available to enable real-time audio-video collaborations/visits through communications services engine using its Media Gateway, real-time audio-video streaming and recording, activated voice response (AVR) and/or interactive voice response (IVR) functionality through AVR/IVR Services, and Instant Images API 93 which captures and stores using real-time video stream during a real-time collaboration session by the authorized users.

6. The system of claim 1, wherein the video is captured by a video camera capturing means and audio is recorded using audio recording means.

7. The system of claim 6, wherein the video camera capturing means may be a wired video camera or wireless video camera.

8. The system of claim 6, wherein the audio recording means may be in form of an external microphone or integral microphone with video capturing means.

9. The system of claim 6, wherein is stored with intelligent indexing for quick retrieval and for providing context sensitive playback when requested.

10. The system of claim 6, wherein the captured video made available for a user as a part of the integrated web-browser application.

11. The system of claim 6, wherein the recorded audio made available for a user as a part of the integrated web-browser application.
